(19) United States
(12) Patent Application Publication
(10) Pub. No.: US 2022/0304305 A1
(43) Pub. Date: Sep. 29, 2022

(54) HIGHLY EFFECTIVE FORMULATIONS ON THE BASIS OF 2-[(2,4-DICHLORPHENYL)-METHYL]-4,4'-DIMETHYL-3-ISOXAZOLIDINONES AND PREEMERGENCE HERBICIDES

(71) Applicant: Bayer Aktiengesellschaft, Leverkusen (DE)

(72) Inventors: Jens KRAUSE, Leverkusen (DE); Arianna MARTELLETTI, Sulzbach im Taunus (DE); Udo BICKERS, Koeln (DE); Arno RATSCHINSKI, Duesseldorf (DE)

(21) Appl. No.: 17/642,191

(22) PCT Filed: Sep. 9, 2020
(86) PCT No.: PCT/EP2020/075171

§ 371 Date: Mar. 10, 2022

(30) Foreign Application Priority Data
Sep. 11, 2019 (EP) 19196784.3

(51) Int. Cl. A01N 43/82; A01N 43/80

(52) U.S. Cl. CPC A01N 43/82; A01N 43/80

(57) ABSTRACT

The present invention relates to formulations based on 2-[(2,4-dichlorophenyl)methyl]-4,4′-dimethyl-3-isoxazolidinones and a preemergence herbicide, to their preparation and to mixtures thereof, and to their use as an agrochemical formulation with improved biological action and enhanced control of broadleaf and gramineous weeds.

The present invention relates to formulations based on 2-[(2,4-dichlorophenyl)methyl]-4,4′-dimethyl-3-isoxazolidinones and a preemergence herbicide, to their preparation and to mixtures thereof, and to their use as an agrochemical formulation with improved biological action and enhanced control of broadleaf and gramineous weeds.

The active ingredient 2-[(2,4-dichlorophenyl)methyl]-4,4′-dimethyl-3-isoxazolidinone (CAS number 81777-95-9 or IUPAC 2-(2,4-dichlorobenzyl)-4,4-dimethyl-1,2-oxazolidin-3-one, abbreviated hereinafter to DCPMI), and also, for example, as a preemergence herbicide flufenacet, 4′-fluoro-N-isopropyl-2-(5-trifluoromethyl-1,3,4-thiadiazol-2-yloxy)acetanilide, abbreviated hereinafter to FFA, are active herbicidal ingredients. The two active ingredients are used typically in aqueous formulations such as, for instance, capsule suspension and suspension concentrates. The formulations are usually applied preemergence, with preemergence referring here to the emergence of the broadleaf and gramineous weeds. The active ingredients here, rather than acting via leaf uptake, are spread over the soil and then taken up via the roots, the seed and/or the plant just as it has started germinating (hypocotyl).

DCPMI is used in herbicidal compositions and mixtures or employed as a selective grass herbicide, as described, for example, in WO2015/127259 A1 or WO2012/148689 A. Capsule suspensions (CS) and suspension concentrates (SC) of DCPMI are known from WO2019/076744, WO 2018/024839 and PCT/EP2019/061009 and also from WO2015/127259.

Active ingredient formulations for foliar applications are typically optimized by addition of penetration enhancers, such as, for instance, oils or ethoxylated alcohols, in such a way that the active ingredient penetrates quickly through the leaf into the plant.

In the case of soil application, conversely, there are only a few known auxiliaries that ensure improved uptake into the seed, germinating plant or root. In addition, with soil application, not only is the mechanism of action of the auxiliaries unknown in the majority of cases, but also the activity of the auxiliaries is very heavily dependent on the active ingredient. Thus there are also only very few auxiliaries known which influence soil uptake. Known formulations include those containing humectants, as described in WO2014/159948. Likewise known are phenoxypolyalkylenoxy sulfates or phosphates as described in WO 2018/141594.

A disadvantage of the known formulations is that the weed control action is often inadequate, so either achieving at best an insufficient effect or necessitating high usage rates.

DCPMI is often applied using capsule suspensions, which are also even weaker in their effect than suspension concentrates.

A further disadvantage of the known formulations is that auxiliaries often have at best a much weaker effect under dry conditions. Given the plain impossibility to the farmer of a long-term weather forecast over weeks or even possibly over months in the case of fall application, there is a need for a reliable formulation whose very good activity remains consistent under both humid and wet conditions.

An object of the invention, thus, was to provide optimized formulations displaying, under both humid and dry conditions, a significantly better effect than the known formulations. The optimized effect here ought to be manifested preemergence in particular. The effect here ought not only to be better, but also to remain consistently high under humid and dry conditions.

As well as the boosted effect, it is desirable for the crop selectivity not to be lowered.

The object of the present invention has been achieved with the formulations of the invention as described below.

The present invention therefore provides (agrochemical) formulations comprising

a) DCPMI and/or at least one preemergence herbicide,
b) at least one dispersant,
c) at least one activity enhancer selected from the group encompassing organically modified (poly)-glycosides and/or -furanoses and/or -pyranoses, and/or organically modified sorbitans and/or sorbitols,
d) optionally at least one agrochemical active compound different from a),
e) optionally at least one safener,
f) optionally at least one thickener, and
g) optionally further additives and auxiliaries,
h) water.

In one preferred embodiment components d) to g) are mandatory.

Suitable preemergence herbicides a) are preferably selected from the group encompassing acetochlor, aclonifen, flufenacet, diflufenican, clomazone, pendimethalin, pyroxasulfone, cinmethylin, and dimethenamid, and more preferably flufenacet and pyroxasulfone, and very preferably flufenacet.

The non-a) active agrochemical ingredients d) may be selected from the group of herbicides, insecticides, fungicides, and nematicides; preferably, d) is a further herbicide.

Likewise provided by the present invention are water-dispersible suspension concentrates (SC), capsule suspension concentrates (CS), and also mixtures of SC and CS ((ZC) formulations) obtainable by the method of the invention.

The SC of the invention can be produced by those methods known in the prior art, for example by wet grinding of the components in bead mills (such as discontinuous bead mills or continuous bead mills), or colloid mills (such as toothed colloid mills). The CS are produced by interfacial polymerization.

The proportion of water in the formulations according to the invention may generally be 25 to 98% by weight, preferably 35 to 85% by weight, with water supplementing the proportion of components a)-g) to 100% by weight.

The unit “% by weight” (percent by weight) here and throughout the description, unless defined otherwise, relates to the relative weight of the particular component based on the total weight of the formulation, with formulation here describing the non-water-diluted, non-application-ready composition.

The formulation may typically contain residues of organic solvents from the additives of 0 to 5.0% by weight, more preferably of from 0.05 to 4.0% by weight, and very preferably of 0.1 to 2.5% by weight.

The proportion of active ingredient a) in the formulations of the invention is preferably 0.5 to 55.0% by weight, further preferably 0.5 to 45.0% by weight, more preferably 0.5 to 40.0% by weight and most preferably 10.0 to 40.0% by weight.

If further active compounds d) are present, the total proportion of components a) and d) is preferably 0.5 to 55.0% by weight, more preferably 0.5 to 45.0% by weight, more preferably still 5.0 to 40.0% by weight and very preferably 10.0 to 40.0% by weight, meaning that the proportion of component a) is reduced by component d).

The proportion of dispersant (component b) is preferably 1.0 to 15.0% by weight, more preferably 2.0 to 10.0% by weight and very particularly preferably 2.5 to 8.0% by weight.

The proportion of the activity enhancer c) in the formulations of the invention is preferably 5.0 to 95.0% by weight, more preferably 10.0 to 90.0% by weight and very particularly preferably 20.0 to 80.0% by weight.

The proportion of the safeners e) in the formulations of the invention is preferably from 0 to 20% weight, more preferably 0 to 15% by weight, very preferably 0 to 10% by weight.

In an alternative embodiment wherein the safeners are mandatory, the proportion of the safeners e) in the formulations of the invention is preferably from 0.01 to 20% by weight, more preferably 0.1 to 15% by weight, very preferably 0.1 to 10% by weight.

The proportion of the thickeners f) in the formulations of the invention is preferably from 0 to 2.0% by weight, more preferably 0.01 to 1.00% by weight, very preferably 0.01 to 0.60% by weight, very particularly preferably 0.04 to 0.50% by weight and very particularly preferably 0.05 to 0.3% by weight.

The proportion of any further auxiliaries and additives g) added in the dispersions of the invention is preferably 0 to 20.0% by weight, with preference 1.0 to 15.0% by weight, more preferably 3.0 to 10.0% by weight and very preferably 5.0 to 10.0% by weight.

In respect of the abovementioned proportions of the respective ingredients, it will be clear to the person skilled in the art that the preferred ranges for the individual ingredients can be combined freely with one another, and so these compositions of different preferred ranges for individual ingredients are also considered to be disclosed.

However, particular preference is given, unless stated otherwise, to preferred ranges from the same level, i.e. for example all preferred or more preferred ranges, where a specific disclosure is intended not to replace these general combinations, but to add to them. A combination of the most preferred (smallest) preferred ranges is especially preferred.

The same applies to other specifications of preferred ranges elsewhere in the present description.

In a preferred embodiment, the proportion of component

a) is 0.5 to 55% by weight
b) is 1.0 to 15% by weight,
c) is 5 to 95% by weight
d) is 0%
e) is 0%,
f) is 0% to 1.00% by weight, and
g) is 0 to 20% by weight,
with water being added to 100% by weight.

In a more preferred embodiment, the proportion of component

a) is 0.5 to 45% by weight
b) is 1.0 to 15% by weight,
c) is 10 to 90% by weight
d) optionally at least one agrochemical active compound different from a),
e) is 0 to 15.0% by weight,
f) is 0.01 to 1.00% by weight, and
g) is 1 to 15% by weight,
with water being added to 100% by weight.

In a further preferred embodiment, the proportion of component

a) is 5 to 40% by weight,
b) is 2.0 to 10% by weight,
c) is 20 to 80% by weight
d) optionally at least one agrochemical active compound different from a),
e) is 0 to 10.0% by weight,
f) is 0.01 to 0.60% by weight, and
g) is 3.0 to 10.0% by weight,
with water being added to 100% by weight.

In a further preferred embodiment, the proportion of component

a) is 10 to 40% by weight
b) is 2.50 to 8.0% by weight,
c) is 20 to 80% by weight
d) at least one active agrochemical ingredient different from a),
e) is 0 to 10.0% by weight,
f) is 0.04 to 0.50% by weight, and
g) is 5.0 to 10.0% by weight,
with water being added to 100% by weight.

In an alternative embodiment, the proportion of component

a) is 10 to 40% by weight
b) is 2.50 to 8.0% by weight,
c) is 20 to 80% by weight
d) at least one active agrochemical ingredient different from a),
e) is 0.1 to 10.0% by weight,
f) is 0.04 to 0.50% by weight, and
g) is 5.0 to 10.0% by weight,
with water being added to 100% by weight.

Dispersants b) are ionic or nonionic surfactants. Suitable anionic dispersants b), such as emulsifiers, surfactants, wetting agents and dispersers, are, for example, alkali metal, alkaline earth metal or ammonium salts of sulfonates, sulfates, phosphates, carboxylates and mixtures thereof, for example the salts of alkylsulfonic acids or alkylphosphoric acids and alkylarylsulfonic or alkylarylphosphoric acids, diphenylsulfonates, alpha-olefinsulfonates, lignosulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols or of fatty acid esters. Examples of phosphates are phosphate esters. Examples of carboxylates are alkyl carboxylates and carboxylated alcohol ethoxylates or alkylphenol ethoxylates. Likewise suitable is the group of anionic emulsifiers of the alkali metal, alkaline earth metal and ammonium salts of the polystyrenesulfonic acids, salts of the polyvinylsulfonic acids, salts of the alkylnaphthalenesulfonic acids, salts of alkylnaphthalenesulfonic acid-formaldehyde condensation products, salts of condensation products of naphthalenesulfonic acid, phenolsulfonic acid and formaldehyde. Examples are calcium dodecylbenzenesulfonate such as Rhodocal® 70/B (Solvay), Phenylsulfonat CA100 (Clariant) or isopropylammonium dodecylbenzenesulfonates such as Atlox® 3300B (Croda).

Further typical representatives include Soprophor® products (optionally esterified derivatives of tristyrylphenol ethoxylates), Emulsogen® 3510 (alkylated EO/PO copolymer), Emulsogen® EL 400 (ethoxylated castor oil), Tween® products (fatty-acylated sorbitan ethoxylates), and Calsogen® AR 100 (calcium dodecylbenzenesulfonate). Preference is given to combinations of salts of alkylated aromatic sulfonic acids, such as calcium phenylsulfonate and/or Calsogen® AR 100, with alkylated copolymers of ethylene oxide and propylene oxide, such as Emulsogen® 3510. Particular preference is given to combinations of salts of dodecylbenzenesulfonic acid, such as Calsogen® AR 100, with alkylated copolymer of ethylene oxide and propylene oxide, such as Emulsogen® 3510.

Examples of further anionic emulsifiers b) from the group of the naphthalenesulfonates are Galoryl® MT 800 (sodium dibutylnaphthalenesulfonic acid), Morwet® IP (sodium diisopropylnaphthalenesulfonate) and Nekal® BX (alkylnaphthalenesulfonate). Examples of anionic surfactants from the group of the condensates of naphthalenesulfonates with formaldehyde are Galoryl® DT 201 (naphthalenesulfonic acid hydroxy polymer with formaldehyde and methylphenol sodium salt), Galoryl® DT 250 (condensate of phenol- and naphthalenesulfonates), Reserve® C (condensate of phenol- and naphthalenesulfonates) or Morwet® D-425, Tersperse® 2020. Preference is given to 1,2-dibutyl- or -diisobutyl-substituted naphthalenesulfonates, for example products such as Galoryl® MT 800 (CFPI-Nufarm) and Nekal® BX (BASF). Further typical surfactants are Soprophor® 3D33, Soprophor® 4D384, Soprophor® BSU, Soprophor® CY/8 (Solvay) and Hoe® 53474, and in the form of the Sapogenat® T products (Clariant), for example Sapogenat® T 100. Further typical representatives are based on lignin (such as lignosulfonates, Borresperse® NA, REAX® 88 or Kraftsperse® 25 S).

From the abovementioned anionic dispersing assistants b), preference is given to using various sulfonates, particularly preferably those based on naphthalene.

Useful nonionic dispersants b), such as emulsifiers, wetting agents, surfactants and dispersers, include standard surface-active substances present in formulations of active agrochemical ingredients. Examples include ethoxylated nonylphenols, reaction products of linear or branched alcohols with ethylene oxide and/or propylene oxide, ethylene oxide-propylene oxide block copolymers, end group-capped and non-end group-capped alkoxylated linear and branched, saturated and unsaturated alcohols (e.g. butoxy polyethylenepropylene glycols), reaction products of alkylphenols with ethylene oxide and/or propylene oxide, ethylene oxide-propylene oxide block copolymers, polyethylene glycols and polypropylene glycols, and also fatty acid esters, fatty acid polyglycol ether esters, alkylsulfonates, alkylsulfates, arylsulfates, ethoxylated arylalkylphenols, for example tristyrylphenol ethoxylate having an average of 16 ethylene oxide units per molecule, and also ethoxylated and propoxylated arylalkylphenols, and also sulfated or phosphated arylalkylphenol ethoxylates or ethoxy- and propoxylates. Particular preference is given to tristyrylphenol alkoxylates and fatty acid polyglycol ether esters. Very particular preference is given to tristyrylphenol ethoxylates, tristyrylphenol ethoxy propoxylates and castor oil polyglycol ether esters, in each case individually or in mixtures. Additives may additionally be useful, such as surfactants or esters of fatty acids, which contribute to improvement in biological efficacy. Suitable nonionic emulsifiers b2) are, for example, Soprophor® 796/P, Lucramul® CO 30, Lucramul® HOT 5902, Lucramul® PSI 100 or Synperonic® T304.

Suitable nonionic dispersers b) may likewise be selected from the group containing polyvinylpyrrolidone (PVP), polyvinyl alcohol, copolymer of PVP and dimethylaminoethyl methacrylate, butylated PVP, copolymer of vinyl chloride and vinyl acetate, and partially hydrolyzed vinyl acetate, phenolic resins, modified cellulose types, for example Luviskol® (polyvinylpyrrolidone), Mowiol® (polyvinyl alcohol) or modified cellulose. Preference is given to polyvinylpyrrolidone types, particular preference to types of low molecular weight such as Luviskol® K30 or Sokalan® K30.

Useful further nonionic emulsifiers b), used preferably, from the group of the di- and triblock copolymers of alkylene oxides are, for example, compounds based on ethylene oxide and propylene oxide, having mean molar masses between 200 and 10 000 and preferably 1000 to 4000 g/mol, where the proportion by mass of the polyethoxylated block varies between 10% and 80%, for example the Synperonic® PE series (CRODA), the Pluronic® PE series (BASF), VOP® 32 or the Genapol® PF series (Clariant). The molar masses are determined, unless otherwise stated, by GPC using chloroform as eluent and polystyrene as standard.

Used more preferably as dispersant is a combination of at least one ionic and one nonionic dispersant.

Component c) is preferably selected from the group encompassing the organically modified (poly)glycosides, organically modified furanoses, organically modified pyranoses, and organically modified sorbitans and sorbitols, and also mixtures thereof.

The group of the organically modified (poly)glycosides more preferably comprises nonionic alkylpolysaccharides (e.g., alkylpolyglucosides or APGs).

Suitable alkylpolysaccharides in the present invention have a structure of formula (I):

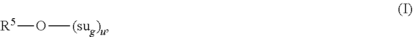

where R5 is an unbranched or branched, optionally substituted or unsubstituted hydrocarbyl radical selected from the group consisting of alkyl, alkenyl, alkylphenyl and alkenylphenyl, preferably having 4 to 22 carbon atoms. Here a person skilled in the art appreciates that alkenylphenyl and alkylphenyl must each contain at least 7 carbon atoms.

The su_{g} unit is a saccharide radical with open or cyclic structure (i.e., pyranose/furanose structure). The saccharide radical is preferably selected from the group encompassing monosaccharides, more preferably monosaccharides having 5 or 6 carbon atoms, disaccharides, and polysaccharides. Saccharide radicals suitable in the invention, including their corresponding pyranose or furanose structures, preferably comprise ribose, xylose, arabinose, glucose, galactose, mannose, telose, gulose, allose, altrose, idose, lyxose, ribulose, sorbose (sorbitan), fructose, and mixtures thereof.

Disaccharide radicals suitable in the invention preferably comprise maltose, lactose and sucrose.

Disaccharides, oligosaccharides and polysaccharides may be a composition of two or more identical saccharides-maltose, for example, is constructed of two glucose units—or two or more different saccharides—sucrose, for example, is composed of glucose and fructose.

The degree of polymerization of oligo- and polysaccharides, u, is an average value preferably from 1 to 10, more preferably from 1 to 8, more preferably still from 1 to 5, even more preferably from 1 to 3, and particularly preferably from 1 to 2.

As the person skilled in the art is aware, and as shown in the formula (I), the radical R⁵ is bonded on an oxygen atom of the su_{g} unit.

In one preferred embodiment the alkylpolysaccharide may be an alkylpolyglycoside (APG) of the formula (I), where R5 is an unbranched or branched alkyl radical having preferably 4 to 22 carbon atoms, more preferably 8 to 18 carbon atoms, more preferably still 8 to 10 carbon atoms, or a mixture of alkyl groups having an average carbon atoms value within the aforesaid ranges; and where su_{g} is preferably a glucuso radical (e.g., a glucoside), and where u is preferably in the range of 1-5, more preferably from 1 to 3.

In another preferred embodiment the alkylpolysaccharide is an alkylpolyglycoside (APG) of the formula (I), where R5 is an unbranched or branched alkyl radical having preferably 8 to 10 carbon atoms, or a mixture of alkyl groups having an average carbon atoms value within the aforesaid ranges; and where su_{g} is preferably a glucuso radical (e.g., a glucoside), and where u is in the range from 1 to 3.

Examples of alkylpolysaccharides of formula (I) according to the invention are known to the person skilled in the art, and preferred such compounds are listed below, with su_{g} of formula (I) in these compounds being glucose: AGNIQUE® PG8107-G, AGNIQUE® PG 8107-U, AGNIQUE® PG 9116, AGNIQUE® PG 8105 U, AGNIQUE® PG 8105 G, AGNIQUE PG® 8105 C (all available from BASF).

In an alternative preferred embodiment component c) is selected from the group encompassing the organically modified sorbitans and/or sorbitols.

One example of an alkoxylated polysorbate ester of formula (II) has the following structure:

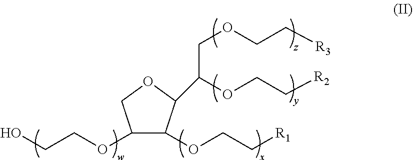

R1, R2 and R3 are fatty acid radicals or a hydroxyl radical where the fatty acid preferably comprises a C10 to C20 fatty acid, more preferably a C12 to C18 fatty acid, and very preferably is selected from the group encompassing oleic acid, stearic acid and lauric acid. The substituents R1 to R3 here may be identical or different.

Representatives of this class are identified below; Tween 80 is particularly preferred.

Tween 85: R1=R2=R3=oleic acid

Tween 80: R1=R2=OH; R3=oleic acid

Tween 60: R1=R2=OH; R3=stearic acid

Tween 20: R1=R2=OH; R3=lauric acid

As an example here, the structure of Tween® 80:

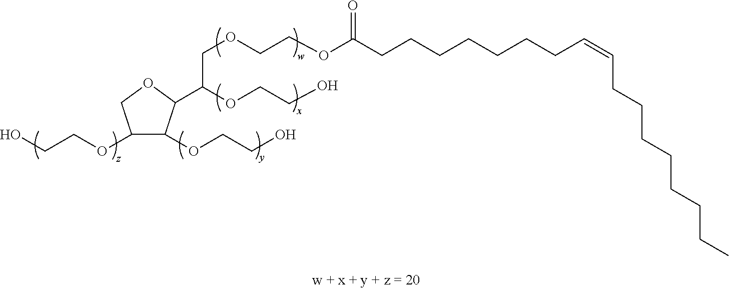

w, x, y and z are integers, preferably from 0 to 20, preferably 0 to 15, more preferably 0 to 10, where 0 corresponds to an OH group.

In an alternative embodiment some or all of the EO units (ethylene oxide as shown in formula II) may be replaced with PO (propylene oxide), e.g., Tween® L-1505 (from CRODA) with 15 EO and 5 PO units.

Examples of adjuvants of structure (II) are known to the person skilled in the art; the relevant commercial products are listed below:

| Product | mol EO | mol PO | log P |
|---|---|---|---|
| Tween 21 | 4 | 0 | 2.71 |
| Tween 22 | 8 | 0 | 1.90 |
| Tween 23 | 12 | 0 | 1.08 |
| Tween 24 | 16 | 0 | 0.26 |
| Tween 20 | 20 | 0 | −0.55 |
| Tween 80 | 20 | 0 | 1.99 |
| Tween 60 | 20 | 0 | 2.48 |
| Tween 40 | 20 | 0 | 1.47 |
| Tween L-0515 | 5 | 15 | 7.44 |
| Tween L-1010 | 10 | 10 | 4.68 |
| Tween L-1505 | 15 | 5 | 1.92 |

Particularly preferred in the present specification are Tween® 80 and Tween® L-1505.

In an alternative embodiment c) is selected from the group of the organically modified (poly)glycosides.

In another alternative embodiment c) is selected from the group of the alkoxylated polysorbate esters of formula (II).

With particular preference the adjuvant c) also has a log P in the range of 0 to 8, more preferably of 0.1 to 5, and particularly preferably of 0.5 to 4.0.

With very particular preference the log P is +−2 units more or less than the log P of the active ingredient a).

Agrochemical active compounds different from component a) (component d) are herbicides, fungicides, insecticides, plant growth regulators and the like.

Fungicidally active compounds are, for example, 1) ergosterol biosynthesis inhibitors, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazole, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) 2-[4-(4-chlorophenoxy)-2-(trifluoromethyl)phenyl]-1-(1H-1,2,4-triazol-1-yl)propan-2-ol, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) mefentrifluconazole, (1.082) ipfentrifluconazole.

2) Inhibitors of the respiratory chain in complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of the syn-epimeric racemate 1RS,4SR,9RS and the anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) 3-(difluoromethyl)-N-(7-fluoro-1,1,3-trimethyl-2,3-dihydro-1H-inden-4-yl)-1-methyl-1H-pyrazole-4-carboxamide, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) N-(5-chloro-2-isopropylbenzyl)-N-cyclopropyl-3-(difluoromethyl)-5-fluoro-1-methyl-1H-pyrazole-4-carboxamide, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide.

3) Respiratory chain inhibitors acting on complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadon, (3.010) fenamidon, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) 2-{2-[(2,5-dimethylphenoxy)methyl]phenyl}-2-methoxy-N-methylacetamide, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate.

4) Mitosis and cell division inhibitors, for example (4.001) carbendazim, (4.002) diethofencarb, (4.003) ethaboxam, (4.004) fluopicolid, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine.

5) Compounds with multisite activity, for example (5.001) Bordeaux mixture, (5.002) captafol, (5.003) captan, (5.004) chlorthalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) zinc metiram, (5.017) copper oxine, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable of triggering host defence, for example (6.001) acibenzolar-S-methyl, (6.002) isotianil, (6.003) probenazole, (6.004) tiadinil.

7) Amino acid and/or protein biosynthesis inhibitors, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

(8) ATP production inhibitors, for example (8.001) silthiofam.

9) Cell wall synthesis inhibitors, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Lipid and membrane synthesis inhibitors, for example (10.001) propamocarb, (10.002) propamocarb hydrochloride, (10.003) tolclofos-methyl.

11) Melanin biosynthesis inhibitors, for example (11.001) tricyclazole, (11.002) 2,2,2-trifluoroethyl-{3-methyl-1-[(4-methylbenzoyl)amino]butan-2-yl}carbamate.

12) Nucleic acid synthesis inhibitors, for example (12.001) benalaxyl, (12.002) benalaxyl-M (kiralaxyl), (12.003) metalaxyl, (12.004) metalaxyl-M (mefenoxam).

13) Signal transduction inhibitors, for example (13.001) fludioxonil, (13.002) iprodione, (13.003) procymidone, (13.004) proquinazid, (13.005) quinoxyfen, (13.006) vinclozolin.

14) Compounds that can act as decouplers, for example (14.001) fluazinam, (14.002) meptyldinocap.

15) Further compounds, for example (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminum, (15.013) fosetyl-calcium, (15.014) fosetyl-sodium, (15.015) methyl isothiocyanate, (15.016) metrafenon, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphonic acid and salts thereof, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) 2,6-dimethyl-1H,5H-[1,4]dithiino[2,3-c:5,6-c′]dipyrrole-1,3,5,7(2H,6H)-tetrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) 2-{2-[(7,8-difluoro-2-methylquinolin-3-yl)oxy]-6-fluorophenyl}propan-2-ol, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts thereof, (15.046) 3-(4,4,5-trifluoro-3,3-dimethyl-3,4-dihydroisoquinolin-1-yl)quinoline, (15.047) 3-(4,4-difluoro-3,3-dimethyl-3,4-dihydroisoquinolin-1-yl)quinoline, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butyric acid, (15.050) 5-amino-1,3,4-thiadiazole-2-thiol, (15.051) 5-chloro-N′-phenyl-N’-(prop-2-yn-1-yl)thiophene 2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one. Examples of active insecticidal ingredients are:

(1) Acetylcholinesterase (AChE) inhibitors, for example carbamates, e.g. alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, e.g. acephate, azamethiphos, azinphos-ethyl, azinphos-methyl, cadusafos, chlorethoxyfos, chlorfenvinphos, chlormephos, chloropyrifos, chloropyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel antagonists, for example cyclodiene-organochlorines, e.g. chlordane and endosulfan or phenylpyrazoles (fiproles), e.g. ethiprole and fipronil.

(3) Sodium channel modulators/voltage-gated sodium channel blockers, for example pyrethroids, e.g. acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans isomers], deltamethrin, empenthrin [(EZ)-(1R) isomers], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin [(1R)-trans isomer], prallethrin, pyrethrins (pyrethrum), resmethrin, silafluofen, tefluthrin, tetramethrin, tetramethrin [(1R) isomers)], tralomethrin and transfluthrin or DDT or methoxychlor.

(4) Nicotinergic acetylcholine receptor (nAChR) agonists, for example neonicotinoids, e.g. acetamiprid, clothianidin, dinotefuran, imidacloprid, nitenpyram, thiacloprid and thiamethoxam or nicotine or sulfoxaflor or flupyradifurone.

(5) Nicotinergic acetylcholine receptor (nAChR) allosteric activators, for example spinosyns, e.g. spinetoram and spinosad.

(6) Chloride channel activators, for example avermectins/milbemycins, e.g. abamectin, emamectin benzoate, lepimectin and milbemectin.

(7) Juvenile hormone mimics, for example, juvenile hormone analogues, e.g. hydroprene, kinoprene and methoprene or fenoxycarb or pyriproxyfen.

(8) Active compounds with unknown or non-specific mechanisms of action, for example alkyl halides, e.g. methyl bromide and other alkyl halides; or chloropicrin or sulfuryl fluoride or borax or tartar emetic.

(9) Selective antifeedants, e.g. pymetrozine or flonicamid.

(10) Mite growth inhibitors, e.g. clofentezine, hexythiazox and diflovidazin or etoxazole.

(11) Microbial disruptors of insect midgut membranes, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1Fa, Cry2Ab, mCry3A, Cry3Ab, Cry3Bb, Cry34/35Ab1.

(12) Oxidative phosphorylation inhibitors, ATP disruptors, for example diafenthiuron or organotin compounds, e.g. azocyclotin, cyhexatin and fenbutatin oxide or propargite or tetradifon.

(13) Uncouplers of oxidative phosphorylation via disruption of the H proton gradient, for example chlorfenapyr, DNOC and sulfluramid.

(14) Nicotinergic acetylcholine receptor antagonists, for example bensultap, cartap hydrochloride, thiocyclam, and thiosultap-sodium.

(15) Inhibitors of chitin biosynthesis, type 0, for example bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1, for example buprofezin.

(17) Moulting disruptors, dipteran, for example cyromazine.

(18) Ecdysone receptor agonists, for example chromafenozide, halofenozide, methoxyfenozide and tebufenozide.

(19) Octopaminergic agonists, for example amitraz.

(20) Complex III electron transport inhibitors, for example hydramethylnon or acequinocyl or fluacrypyrim.

(21) Complex I electron transport inhibitors, for example METI acaricides, e.g. fenazaquin, fenpyroximate, pyrimidifen, pyridaben, tebufenpyrad and tolfenpyrad or rotenone (Derris).

(22) Voltage-gated sodium channel blockers, for example indoxacarb or metaflumizone.

(23) Inhibitors of acetyl-CoA carboxylase, for example tetronic and tetramic acid derivatives, e.g. spirobudiclofen, spirodiclofen, spiromesifen and spirotetramat.

(24) Complex IV electron transport inhibitors, for example phosphines, e.g. aluminum phosphide, calcium phosphide, phosphine and zinc phosphide or cyanide.

(25) Complex II electron transport inhibitors, for example cyenopyrafen and cyflumetofen.

(28) Ryanodine receptor effectors, for example diamides, e.g. chlorantraniliprole, cyantraniliprole, flubendiamide and tetrachloroantraniliprole.

Further insecticidally active compounds having an unknown or unclear mechanism of action, for example afidopyropen, afoxolaner, azadirachtin, benclothiaz, benzoximate, bifenazate, broflanilide, bromopropylate, chinomethionat, cryolite, cyclaniliprole, cycloxaprid, cyhalodiamide, dicloromezotiaz, dicofol, diflovidazin, flometoquin, fluazaindolizine, fluensulfone, flufenerim, flufenoxystrobin, flufiprole, fluhexafon, fluopyram, fluralaner, fluxametamide, fufenozide, guadipyr, heptafluthrin, imidaclothiz, iprodione, lotilaner, meperfluthrin, paichongding, pyflubumide, pyridalyl, pyrifluquinazon, pyriminostrobin, sarolaner, tetramethylfluthrin, tetraniliprole, tetrachlorantraniliprole, tioxazafen, thiofluoximate, triflumezopyrim and iodomethanes; and additionally preparations based on Bacillus firmus (I-1582, BioNeem, Votivo), and the following known active compounds: 1-{2-fluoro-4-methyl-5-[(2,2,2-trifluoroethyl)sulphinyl]phenyl}-3-(trifluoromethyl)-1H-1,2,4-triazole-5-amine (known from WO2006/043635), {1′-[(2E)-3-(4-chlorophenyl)prop-2-en-1-yl]-5-fluorospiro[indole-3,4′-piperidin]-1(2H)-yl}(2-chloropyridin-4-yl)methanone (known from WO2003/106457), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-ylethyl carbonate (known from WO2009/049851), 4-(but-2-yn-1-yloxy)-6-(3,5-dimethylpiperidin-1-yl)-5-fluoropyrimidine (known from WO2004/099160), 4-(but-2-yn-1-yloxy)-6-(3-chlorophenyl)pyrimidine (known from WO2003/076415), PF1364 (CAS Reg. No. 1204776-60-2), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate (known from WO2005/085216), N-[2-(5-amino-1,3,4-thiadiazol-2-yl)-4-chloro-6-methylphenyl]-3-bromo-1-(3-chloropyridin-2-yl)-1H-pyrazole-5-carboxamide (known from CN102057925), 4-[5-(3,5-dichlorophenyl)-5-(trifluoromethyl)-4,5-dihydro-1,2-oxazol-3-yl]-2-methyl-N-(1-oxidothietan-3-yl)benzamide (known from WO2009/080250), N-[(2E)-1-[(6-chlorpyridin-3-yl)methyl]pyridin-2(1H)-yliden]-2,2,2-trifluoracetamide (known from WO2012/029672), 1-[(2-chloro-1,3-thiazol-5-yl)methyl]-4-oxo-3-phenyl-4H-pyrido[1,2-a]pyrimidin-1-ium-2-olate (known from WO2009/099929), 1-[(6-chloropyridin-3-yl)methyl]-4-oxo-3-phenyl-4H-pyrido[1,2-a]pyrimidin-1-ium-2-olate (known from WO2009/099929), 4-(3-{2,6-dichloro-4-[(3,3-dichloroprop-2-en-1-yl)oxy]phenoxy}propoxy)-2-methoxy-6-(trifluoromethyl)pyrimidine (known from CN101337940), N-[2-(tert-butylcarbamoyl)-4-chloro-6-methylphenyl]-1-(3-chloropyridin-2-yl)-3-(fluoromethoxy)-1H-pyrazole-5-carboxamide (known from WO2008/134969), butyl 2-(2,4-dichlorophenyl)-3-oxo-4-oxaspiro[4.5]dec-1-en-1-yl carbonate (known from CN 102060818), 3E)-3-[1-[(6-chloro-3-pyridyl)methyl]-2-pyridylidene]-1,1,1-trifluoropropan-2-one (known from WO2013/144213), N-(methylsulfonyl)-6-[2-(pyridin-3-yl)-1,3-thiazol-5-yl]pyridine-2-carboxamide (known from WO2012/000896), N-[3-(benzylcarbamoyl)-4-chlorophenyl]-1-methyl-3-(pentafluoroethyl)-4-(trifluoromethyl)-1H-pyrazole-5-carboxamide (known from WO2010/051926), 5-bromo-4-chloro-N-[4-chloro-2-methyl-6-(methylcarbamoyl)phenyl]-2-(3-chloro-2-pyridyl)pyrazole-3-carboxamide (known from CN103232431), tioxazafen, 4-[5-(3,5-dichlorophenyl)-4,5-dihydro-5-(trifluoromethyl)-3-isoxazolyl]-2-methyl-N-(cis-1-oxido-3-thietanyl)benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013050317 A1), N-[3-chloro-1-(3-pyridinyl)-1H-pyrazol-4-yl]-N-ethyl-3-[(3,3,3-trifluoropropyl)sulfinyl]propanamide, (+)-N-[3-chloro-1-(3-pyridinyl)-1H-pyrazol-4-yl]-N-ethyl-3-[(3,3,3-trifluoropropyl)sulfinyl]propanamide and (−)-N-[3-chloro-1-(3-pyridinyl)-1H-pyrazol-4-yl]-N-ethyl-3-[(3,3,3-trifluoropropyl)sulfinyl]propanamide (known from WO 2013162715 A2, WO 2013162716 A2, US 20140213448 A1), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A), 3-bromo-N-[4-chloro-2-methyl-6-[(methylamino)thioxomethyl]phenyl]-1-(3-chloro-2-pyridinyl)-1H-pyrazole-5-carboxamide, (liudaibenjiaxuanan, known from CN 103109816 A); N-[4-chloro-2-[[(1,1-dimethylethyl)amino]carbonyl]-6-methylphenyl]-1-(3-chloro-2-pyridinyl)-3-(fluoromethoxy)-1H-pyrazole-5-carboxamide (known from WO 2012034403 A1), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011085575 A1), 4-[3-[2,6-dichloro-4-[(3,3-dichloro-2-propen-1-yl)oxy]phenoxy]propoxy]-2-methoxy-6-(trifluoromethyl)pyrimidine (known from CN 101337940 A); (2E)- and 2(Z)-2-[2-(4-cyanophenyl)-1-[3-(trifluoromethyl)phenyl]ethylidene]-N-[4-(difluoromethoxy)phenyl]hydrazinecarboxamide (known from CN 101715774 A); 3-(2,2-dichloroethenyl)-2,2-dimethyl-4-(1H-benzimidazol-2-yl)phenylcyclopropanecarboxylic acid ester (known from CN 103524422 A); methyl (4aS)-7-chloro-2,5-dihydro-2-[[(methoxycarbonyl)[4-[(trifluoromethyl)thio]phenyl]amino]carbonyl]indeno[1,2-e][1,3,4]oxadiazine-4a(3H)carboxylate (known from CN 102391261 A).

Examples of herbicidal mixing partners are:

acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-6-(4-chloro-2-fluoro-3-methylphenyl)-5-fluoropyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bromacil, bromobutide, bromofenoxim, bromoxynil, bromoxynil-butyrate, -potassium, -heptanoate and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, chlorfenac, chlorfenac-sodium, chlorfenprop, chlorflurenol, chlorflurenol-methyl, chloridazon, chlorimuron, chlorimuron-ethyl, chlorophthalim, chlorotoluron, chlorthal-dimethyl, chlorsulfuron, cinidon, cinidon-ethyl, cinosulfuron, clacyfos, clethodim, clodinafop, clodinafop-propargyl, clomeprop, clopyralid, cloransulam, cloransulam-methyl, cumyluron, cyanamide, cyanazine, cycloate, cyclopyrimorate, cyclosulfamuron, cycloxydim, cyhalofop, cyhalofop-butyl, cyprazine, 2,4-D, 2,4-D-butotyl, -butyl, -dimethylammonium, -diolamine, -ethyl, 2-ethylhexyl, -isobutyl, -isooctyl, -isopropylammonium, -potassium, -triisopropanolammonium and -trolamine, 2,4-DB, 2,4-DB-butyl, -dimethylammonium, isooctyl, -potassium and -sodium, daimuron (dymron), dalapon, dazomet, n-decanol, desmedipham, detosyl-pyrazolate (DTP), dicamba, dichlobenil, 2-(2,4-dichlorobenzyl)-4,4-dimethyl-1,2-oxazolidin-3-one, 2-(2,5-dichlorobenzyl)-4,4-dimethyl-1,2-oxazolidin-3-one, dichlorprop, dichlorprop-P, diclofop, diclofop-methyl, diclofop-P-methyl, diclosulam, difenzoquat, diflufenzopyr, diflufenzopyr-sodium, dimefuron, dimepiperate, dimethachlor, dimethametryn, dimetrasulfuron, dinitramine, dinoterb, diphenamid, diquat, diquat-dibromid, dithiopyr, diuron, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, F-9600, F-5231, i.e. N-[2-chloro-4-fluoro-5-[4-(3-fluoropropyl)-4,5-dihydro-5-oxo-1H-tetrazol-1-yl]-phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium and -trimesium, H-9201, i.e. 0-(2,4-dimethyl-6-nitrophenyl)O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, imazamethabenz, Imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, ketospiradox, lactofen, lenacil, linuron, MCPA, MCPA-butotyl, -dimethylammonium, -2-ethylhexyl, -isopropylammonium, -potassium and -sodium, MCPB, MCPB-methyl, -ethyl and -sodium, mecoprop, mecoprop-sodium, and -butotyl, mecoprop-P, mecoprop-P-butotyl, -dimethylammonium, -2-ethylhexyl and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, methyl isothiocyanate, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-[3-chloro-4-(1-methylethyl)phenyl]-2-methylpentanamide, NGGC-011, napropamide, NC-310, i.e. 4-(2,4-dichlorobenzoyl)-1-methyl-5-benzyloxypyrazole, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trifluoroacetic acid), TCA-sodium, tebuthiuron, tefuryltrione, tembotrione, tepraloxydim, terbacil, terbucarb, terbumeton, terbuthylazin, terbutryn, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, XDE-848, ZJ-0862, i.e. 3,4-dichloro-N-{2-[(4,6-dimethoxypyrimidin-2-yl)oxy]benzyl}aniline, and the following compounds.

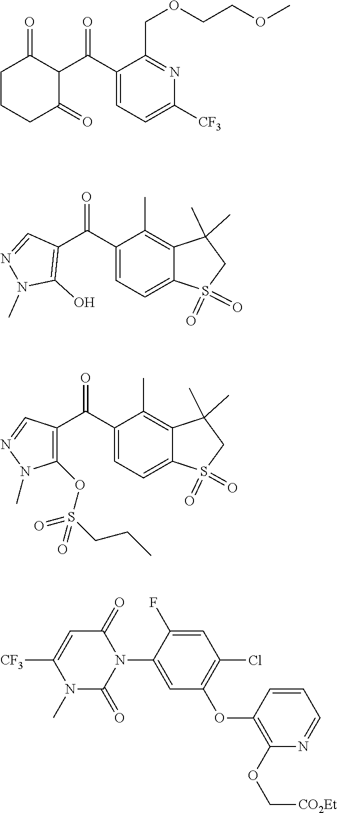 [SMILES: COCCOCc1nc(C(F)(F)F)ccc1C(=O)C1C(=O)CCCC1=O ; Cc1c(C(=O)c2cnn(C)c2O)ccc2c1C(C)(C)CS2(=O)=O ; CCCS(=O)(=O)Oc1c(C(=O)c2ccc3c(c2C)C(C)(C)CS3(=O)=O)cnn1C ; CCOC(=O)COc1ncccc1Oc1cc(-n2c(=O)cc(C(F)(F)F)n(C)c2=O)c(F)cc1Cl]

Examples of plant growth regulators as possible mixing partners are:

acibenzolar, acibenzolar-S-methyl, 5-aminolevulinic acid, ancymidol, 6-benzylaminopurine, brassinolide, catechol, chlormequat chloride, cloprop, cyclanilide, 3-(cycloprop-1-enyl)propionic acid, daminozide, dazomet, n-decanol, dikegulac, dikegulac-sodium, endothal, endothal-dipotassium, -disodium, and mono(N,N-dimethylalkylammonium), ethephon, flumetralin, flurenol, flurenol-butyl, flurprimidol, forchlorfenuron, gibberellic acid, inabenfide, indole-3-acetic acid (IAA), 4-indol-3-ylbutyric acid, isoprothiolane, probenazole, jasmonic acid, jasmonic acid methyl ester, maleic hydrazide, mepiquat chloride, 1-methylcyclopropene, 2-(1-naphthyl)acetamide, 1-naphthylacetic acid, 2-naphthyloxyacetic acid, nitrophenolate mixture, 4-oxo-4[(2-phenylethyl)amino]butyric acid, paclobutrazole, N-phenylphthalamic acid, prohexadione, prohexadione-calcium, prohydrojasmone, salicylic acid, strigolactone, tecnazene, thidiazuron, triacontanol, trinexapac, trinexapac-ethyl, tsitodef, uniconazole, uniconazole-P.

In addition, the SCs according to the invention can contain a safener e). The following groups of compounds, for example, are suitable as safeners (component e):
S1) Compounds from the group of heterocyclic carboxylic acid derivatives:
S1^{a}) Compounds of the dichlorophenylpyrazoline-3-carboxylic acid type (S1^{a}), preferably compounds such as
   1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds as described in WO-A-91/07874;
S1^{b}) Derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds as described in EP-A-333 131 and EP-A-269 806;
S1^{c}) Derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds as described, for example, in EP-A-268554;
S1^{d}) Compounds of the triazolecarboxylic acids type (S1^{d}), preferably compounds such as fenchlorazole (ethyl ester), i.e. ethyl 1-(2,4-dichlorophenyl)-5-trichloromethyl-(1H)-1,2,4-triazole-3-carboxylate (S1-7), and related compounds as described in EP-A-174 562 and EP-A-346 620;
S1^{c}) Compounds of the 5-benzyl- or 5-phenyl-2-isoxazoline-3-carboxylic acid or of the 5,5-diphenyl-2-isoxazoline-3-carboxylic acid type (S1^{c}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds as described in WO-A-91/08202, or 5,5-diphenyl-2-isoxazolinecarboxylic acid (S1-10) or ethyl 5,5-diphenyl-2-isoxazoline-3-carboxylate (S1-11) (“isoxadifen-ethyl”) or n-propyl 5,5-diphenyl-2-isoxazoline-3-carboxylate (S1-12) or ethyl 5-(4-fluorophenyl)-5-phenyl-2-isoxazoline-3-carboxylate (S1-13) as described in patent application WO-A-95/07897.
S2) Compounds from the group of the 8-quinolinoxy derivatives (S2):
S2^{a}) Compounds of the 8-quinolinoxyacetic acid type (S2^{a}), preferably 1-methylhexyl (5-chloro-8-quinolinoxy)acetate (“cloquintocet-mexyl”) (S2-1), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5),
methyl (5-chloro-8-quinolinoxy)acetate (S2-6),
allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds as described in EP-A-86 750, EP-A-94 349 and EP-A-191 736 or EP-A-0 492 366, and also (5-chloro-8-quinolinoxy)acetic acid (S2-10), hydrates and salts thereof, for example the lithium, sodium, potassium, calcium, magnesium, aluminum, iron, ammonium, quaternary ammonium, sulfonium or phosphonium salts thereof, as described in WO-A-2002/34048;
S2^{b}) Compounds of the (5-chloro-8-quinolinoxy)malonic acid type (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
S3) Active ingredients of the dichloroacetamide type (S3), which are frequently used as pre-emergence safeners (soil-acting safeners), for example
“dichlormid” (N,N-diallyl-2,2-dichloroacetamide) (S3-1),
“R-29148” (3-dichloroacetyl-2,2,5-trimethyl-1,3-oxazolidine) from Stauffer (S3-2),
“R-28725” (3-dichloroacetyl-2,2-dimethyl-1,3-oxazolidine) from Stauffer (S3-3),
“benoxacor” (4-dichloroacetyl-3,4-dihydro-3-methyl-2H-1,4-benzoxazine) (S3-4),
“PPG-1292” (N-allyl-N-[(1,3-dioxolan-2-yl)methyl]dichloroacetamide) from PPG Industries (S3-5),
“DKA-24” (N-allyl-N-[(allylaminocarbonyl)methyl]dichloroacetamide) from Sagro-Chem (S3-6),
“AD-67” or “MON 4660” (3-dichloroacetyl-1-oxa-3-azaspiro[4.5]decane) from Nitrokemia or Monsanto (S3-7),
“TI-35” (1-dichloroacetylazepane) from TRI-Chemical RT (S3-8),
“diclonon” (dicyclonon) or “BAS145138” or “LAB145138” (S3-9)
((RS)-1-dichloroacetyl-3,3,8a-trimethylperhydropyrrolo[1,2-a]pyrimidin-6-one) from BASF,
“furilazole” or “MON 13900” ((RS)-3-dichloroacetyl-5-(2-furyl)-2,2-dimethyloxazolidine) (S3-10), and the (R) isomer thereof (S3-11).
S4) Compounds from the class of the acylsulfonamides (S4):
S4^{a}) N-Acylsulfonamides of the formula (S4^{a}) and salts thereof, as described in WO-A-97/45016,

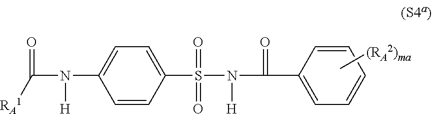

in which
R_{A}¹ is (C₁-C₆)-alkyl, (C₃-C₆)-cycloalkyl, where the 2 latter radicals are substituted by v_{A} substituents from the group of halogen, (C₁-C₄)-alkoxy, (C₁-C₆)-haloalkoxy and (C₁-C₄)-alkylthio and, in the case of cyclic radicals, also by (C₁-C₄)-alkyl and (C₁-C₄)-haloalkyl;
R_{A}² is halogen, (C₁-C₄)-alkyl, (C₁-C₄)-alkoxy, CF₃;
m_{A} is 1 or 2;
v_{A} is 0, 1, 2 or 3;
S4^{b}) Compounds of the 4-(benzoylsulfamoyl)benzamide type of the formula (S4^{b}) and salts thereof, as described in WO-A-99/16744,

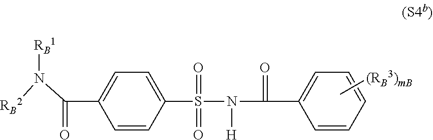

in which
R_{B}¹, R_{B}² are independently hydrogen, (C₁-C₆)-alkyl, (C₃-C₆)-cycloalkyl, (C₃-C₆)-alkenyl, (C₃-C₆)-alkynyl,
R_{B}³ is halogen, (C₁-C₄)-alkyl, (C₁-C₄)-haloalkyl or (C₁-C₄)-alkoxy and
m_{B} is 1 or 2,
e.g. those in which
R_{B}¹=cyclopropyl, R_{B}²=hydrogen and (R_{B}³)=2-OMe (“cyprosulfamide”, S4-1),
R_{B}¹=cyclopropyl, R_{B}²=hydrogen and (R_{B}³)=5-Cl-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B}³)=5-Cl-2-OMe (S4-4) and
R_{B}¹=isopropyl, R_{B}²=hydrogen and (R_{B}³)=2-OMe (S4-5);
S4^{c}) Compounds from the class of the benzoylsulfamoylphenylureas of the formula (S4^{c}), as described in EP-A-365484,

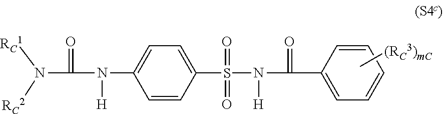

in which
R_{C}¹, R_{C}² are independently hydrogen, (C₁-C₈)-alkyl, (C₃-C₅)-cycloalkyl, (C₃-C₆)-alkenyl, (C₃-C₆)-alkynyl,
R_{C}³ is halogen, (C₁-C₄)-alkyl, (C₁-C₄)-alkoxy, CF₃ and
m_{C} is 1 or 2;
for example
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea;
S₄^{d}) Compounds of the N-phenylsulfonylterephthalamide type of the formula (S₄^{d}) and salts thereof, which are known, for example, from CN 101838227,

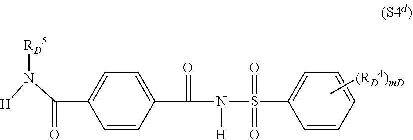

in which
R_{D}⁴ is halogen, (C₁-C₄)-alkyl, (C₁-C₄)-alkoxy, CF₃;
m_{D} is 1 or 2;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl.
S5) Active ingredients from the class of the hydroxyaromatics and the aromatic-aliphatic carboxylic acid derivatives (S5), for example
ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicylic acid, 2-hydroxycinnamic acid, 2,4-dichlorocinnamic acid, as described in WO-A-2004/084631, WO-A-2005/015994, WO-A-2005/016001.
S6) Active ingredients from the class of the 1,2-dihydroquinoxalin-2-ones (S6), for example
1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, as described in WO-A-2005/112630.
S7) Compounds from the class of the diphenylmethoxyacetic acid derivatives (S7), e.g. methyl diphenylmethoxyacetate (CAS Reg. No. 41858-19-9) (S7-1), ethyl diphenylmethoxyacetate or diphenylmethoxyacetic acid, as described in WO-A-98/38856.
S8) Compounds of the formula (S8), as described in WO-A-98/27049,
in which the symbols and indices are defined as follows:

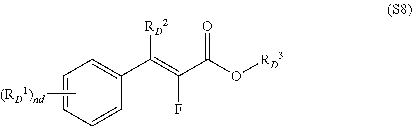

R_{D}¹ is halogen, (C₁-C₄)-alkyl, (C₁-C₄)-haloalkyl, (C₁-C₄)-alkoxy, (C₁-C₄)-haloalkoxy,
R_{D}² is hydrogen or (C₁-C₄)-alkyl,
R_{D}³ is hydrogen, (C₁-C₈)-alkyl, (C₂-C₄)-alkenyl, (C₂-C₄)-alkynyl or aryl, where each of the aforementioned carbon-containing radicals is unsubstituted or substituted by one or more, preferably up to three, identical or different radicals from the group consisting of halogen and alkoxy; or salts thereof,
n_{D} is an integer from 0 to 2.
S9) Active ingredients from the class of the 3-(5-tetrazolylcarbonyl)-2-quinolones (S9), for example
1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No. 95855-00-8), as described in WO-A-1999/000020.
S10) Compounds of the formulae (S10a) or (S10^{b})
   as described in WO-A-2007/023719 and WO-A-2007/023764
in which

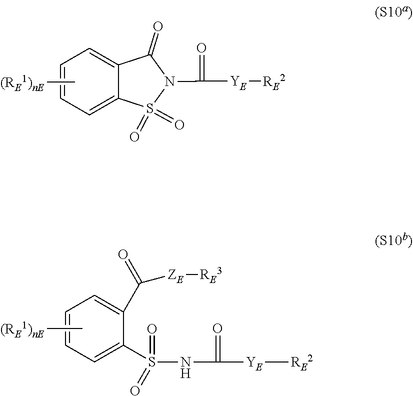

R_{E}¹ is halogen, (C₁-C₄)-alkyl, methoxy, nitro, cyano, CF₃, OCF₃,
Y_{E}, Z_{E} are independently O or S,
n_{E} is an integer from 0 to 4,
R_{E}² is (C₁-C₁₆)-alkyl, (C₂-C₆)-alkenyl, (C₃-C₆)-cycloalkyl, aryl; benzyl, halobenzyl,
R_{E}³ is hydrogen or (C₁-C₆)-alkyl.
S11) Active ingredients of the oxyimino compounds type (S11), which are known as seed-dressing agents, for example
“oxabetrinil” ((Z)-1,3-dioxolan-2-ylmethoxyimino(phenyl)acetonitrile) (S11-1), which is known as a seed-dressing safener for millet/sorghum against metolachlor damage,
   “fluxofenim” (1-(4-chlorophenyl)-2,2,2-trifluoro-1-ethanone O-(1,3-dioxolan-2-ylmethyl)oxime) (S11-2), which is known as a seed-dressing safener for millet/sorghum against metolachlor damage, and
   “cyometrinil” or “CGA-43089” ((Z)-cyanomethoxyimino(phenyl)acetonitrile) (S11-3), which is known as a seed-dressing safener for millet/sorghum against metolachlor damage.
S12) Active ingredients from the class of the isothiochromanones (S12), for example methyl [(3-oxo-1H-2-benzothiopyran-4(3H)-ylidene)methoxy]acetate (CAS Reg. No. 205121-04-6) (S12-1) and related compounds from WO-A-1998/13361.
S13) One or more compounds from group (S13):
   “naphthalic anhydride” (1,8-naphthalenedicarboxylic anhydride) (S13-1), which is known as a seed-dressing safener for corn against thiocarbamate herbicide damage,
   “fenclorim” (4,6-dichloro-2-phenylpyrimidine) (S13-2), which is known as a safener for pretilachlor in sown rice,
   “flurazole” (benzyl 2-chloro-4-trifluoromethyl-1,3-thiazole-5-carboxylate) (S13-3), which is known as a seed-dressing safener for millet/sorghum against alachlor and metolachlor damage,
   “CL 304415” (CAS Reg. No. 31541-57-8)
   (4-carboxy-3,4-dihydro-2H-1-benzopyran-4-acetic acid) (S13-4) from American Cyanamid, which is known as a safener for corn against damage by imidazolinones,
   “MG 191” (CAS Reg. No. 96420-72-3) (2-dichloromethyl-2-methyl-1,3-dioxolane) (S13-5) from Nitrokemia, which is known as a safener for corn,
   “MG 838” (CAS Reg. No. 133993-74-5)
   (2-propenyl 1-oxa-4-azaspiro[4.5]decane-4-carbodithioate) (S13-6) from Nitrokemia
   “disulfoton” (0,0-diethyl S-2-ethylthioethyl phosphorodithioate) (S13-7),
   “dietholate” (0,0-diethyl O-phenyl phosphorothioate) (S13-8),
   “mephenate” (4-chlorophenyl methylcarbamate) (S13-9).
S14) Active ingredients which, in addition to herbicidal action against harmful plants, also have safener action on crop plants such as rice, for example
“dimepiperate” or “MY-93” (S-1-methyl 1-phenylethylpiperidine-1-carbothioate), which is known as a safener for rice against damage by the herbicide molinate,
   “daimuron” or “SK 23” (1-(1-methyl-1-phenylethyl)-3-p-tolylurea), which is known as a safener for rice against damage by the herbicide imazosulfuron,
   “cumyluron”=“JC-940” (3-(2-chlorophenylmethyl)-1-(1-methyl-1-phenylethyl)urea, see JP-A-60087254), which is known as a safener for rice against damage by some herbicides,
   “methoxyphenone” or “NK 049” (3,3′-dimethyl-4-methoxybenzophenone), which is known as a safener for rice against damage by some herbicides,
   “CSB” (1-bromo-4-(chloromethylsulfonyl)benzene) from Kumiai, (CAS Reg. No. 54091-06-4), which is known as a safener against damage by some herbicides in rice.
S15) Compounds of the formula (S15) or tautomers thereof
   as described in WO-A-2008/131861 and WO-A-2008/131860,

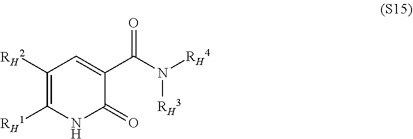

in which
R_{H}¹ is a (C₁-C₆)-haloalkyl radical and
R_{H}² is hydrogen or halogen and
R_{H}³, R_{H}⁴ are independently hydrogen, (C₁-C₁₆)-alkyl, (C₂-C₁₆)-alkenyl or (C₂-C₁₆)-alkynyl,
   where each of the 3 latter radicals is unsubstituted or substituted by one or more radicals from the group of halogen, hydroxyl, cyano, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted,
   or (C₃-C₆)-cycloalkyl, (C₄-C₆)-cycloalkenyl, (C₃-C₆)-cycloalkyl fused on one side of the ring to a 4 to 6-membered saturated or unsaturated carbocyclic ring, or (C₄-C₆)-cycloalkenyl fused on one side of the ring to a 4 to 6-membered saturated or unsaturated carbocyclic ring,
   where each of the 4 latter radicals is unsubstituted or substituted by one or more radicals from the group of halogen, hydroxyl, cyano, (C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted,
   or
R_{H}³ is (C₁-C₄)-alkoxy, (C₂-C₄)-alkenyloxy, (C₂-C₆)-alkynyloxy or (C₂-C₄)-haloalkoxy and
R_{H}⁴ is hydrogen or (C₁-C₄)-alkyl or
R_{H}³ and R_{H}⁴ together with the directly attached nitrogen atom represent a four- to eight-membered heterocyclic ring which, as well as the nitrogen atom, may also contain further ring heteroatoms, preferably up to two further ring heteroatoms from the group of N, O and S, and which is unsubstituted or substituted by one or more radicals from the group of halogen, cyano, nitro, (C₁-C₄)-alkyl, (C₁-C₄)-haloalkyl, (C₁-C₄)-alkoxy, (C₁-C₄)-haloalkoxy and (C₁-C₄)-alkylthio.
S16) Active ingredients which are used primarily as herbicides but also have safener action on crop plants, for example
   (2,4-dichlorophenoxy)acetic acid (2,4-D),
   (4-chlorophenoxy)acetic acid,
   (R,S)-2-(4-chloro-o-tolyloxy)propionic acid (mecoprop),
   4-(2,4-dichlorophenoxy)butyric acid (2,4-DB),
   (4-chloro-o-tolyloxy)acetic acid (MCPA),
   4-(4-chloro-o-tolyloxy)butyric acid,
   4-(4-chlorophenoxy)butyric acid,
   3,6-dichloro-2-methoxybenzoic acid (dicamba),
   1-(ethoxycarbonyl)ethyl 3,6-dichloro-2-methoxybenzoate (lactidichlor-ethyl).

Preferred safeners for the purposes of the present invention are safeners based on the esters of cloquintocet (preferably mexyl ester) and/or mefenpyr (preferably as diethyl ester), particularly preferably mefenpyr diethyl ester.

Preferred thickeners f) are organic thickeners, which may be natural or biotechnologically modified or organically synthetic thickeners.

Typical synthetic thickeners are Rheostrux® (Croda) or the Thixin® or Thixatrol® series (Elementis). These are typically based on acrylates. Typical organic thickeners are based on xanthan or cellulose (for instance hydroxyethyl or carboxymethyl cellulose) or a combination thereof. Preference is given to using natural modified thickeners based on xanthan. Typical representatives are, for example, Rhodopol® (Solvay) and Kelzan® (CPKelco Corp.), and also Satiaxane® (Cargill).

Further thickeners are carrier materials f) preferably selected from the group containing minerals, carbonates, sulfates and phosphates of alkaline earth metals and earth metals, such as calcium carbonate, polymeric carbohydrates, silicas, (natural) framework silicates, such as kaolin. Typical representatives of suitable fillers c) are, for example, Agsorb® LVM-GA (attapulgite), Harborlite® 300 (pearlite), Collys® HV (modified starch), Omya® chalk (calcium carbonate), Kaolin® Tec 1 (kaolin, aluminum hydrosilicate), Steamic® OOS (talc, magnesium silicate).

For f), further preference is given here to natural framework silicates and calcium carbonate products such as Omya® chalk (calcium carbonate), Kaolin® Tec 1 (kaolin) and Harborlite® 300 (pearlite), particular preference to natural framework silicates such as Kaolin®, Tec 1 (kaolin, aluminum hydrosilicate) and Harborlite® 300 (pearlite). Further fillers in the SC formulations of the invention are selected from the group comprising minerals, carbonates, sulfates and phosphates of alkaline earth metals and earth metals, such as calcium carbonate, polymeric carbohydrates, framework silicates, such as precipitated silicas having low absorption, and natural framework silicates, such as kaolin. Typical representatives of suitable fillers c) are, for example, Agsorb® LVM-GA (attapulgite), Harborlite® 300 (pearlite), Collys® HV (modified starch), Omya® chalk (calcium carbonate), Kaolin® Tec 1 (kaolin, aluminum hydrosilicate), Steamic® OOS (talc, magnesium silicate). Suitable examples are modified natural silicates, such as chemically modified bentonites, hectorites, attapulgites, montmorillonites, smectites or other silicate minerals such as Bentone® (Elementis), Attagel® (Engelhard), Agsorb® (Oil-Dri Corporation) or Hectorite® (Akzo Nobel), or the Van Gel® series (R. T. Vanderbilt).

Particular preference is given to carrier materials f) selected from the group of the high absorbency carriers having an absorbency of at least 200 g of dibutyl phthalate per 100 g of carrier material (BET surface according to ISO 9277), for example high absorbency synthetic precipitated silica (Sipernat® types) and pyrogenic silica (Aerosil® types).

Other additives and auxiliaries g) are wetting agents, pH adjusters, defoamers, biocides, disintegrants, adhesion promoters, antifreeze agents, preservatives, dyes or fertilizers, and also surfactants different from component b); preference is given to adding antifreeze agents, defoamers and biocides.

Suitable defoamers are surface-active silicone- or silane-based compounds such as the Tegopren® products (Goldschmidt), the SE® products (Wacker), and the Bevaloid® (Kemira), Rhodorsil® (Solvay) and Silcolapse® products (Blustar Silicones), preference being given to SE® (Wacker), Rhodorsil® and Silcolapse® products, particular preference, for example, to products such as Silcolapse® 5020.

Suitable antifreezes are those from the group of the ureas, diols and polyols, such as ethylene glycol and propylene glycol, glycerol, preferably propylene glycol or glycerol.

Suitable biocides are, for example, products such as Acticide® MBS (Biozid, Thor Chemie), CIT, MIT or BIT, for instance Proxel® GXL (BIT), Acticide® SPX (MIT, CIT).

Suitable adhesion promoters may be selected from the group of polyvinylpyrrolidone (PVP), polyvinyl alcohol, copolymer of PVP and dimethylaminoethyl methacrylate, butylated PVP, copolymer of vinyl chloride and vinyl acetate, sodium salt of the copolymer of propenesultanic acid and partially hydrolyzed vinyl acetate, sodium caseinate, phenol resins, modified cellulose types, for example Luviskol® (polyvinylpyrrolidone), Mowiol® (polyvinyl alcohol), modified cellulose.

Preference is given to polyvinylpyrrolidone types, particular preference to types of low molecular weight such as Luviskol® K30.

Suitable disintegrants may be selected from the group of the modified carbohydrates, such as microcrystalline cellulose and crosslinked polyvinylpyrrolidones, for example Avicel® PH 101 (microcrystalline cellulose), Agrimer® XLF (crosslinked polyvinylpyrrolidone), Disintex® 200 (crosslinked polyvinylpyrrolidone). Preference is given to crosslinked polyvinylpyrrolidones, such as Agrimer® XLF.

Suitable antifoams may be selected from the group of the esters of phosphoric acid with lower alcohols, C6-C10 alcohols, silicone surfactants (suspoemulsions of hydrophobized silica particles in aqueous emulsion concentrates based on liquid silicone surfactants), such as polydimethylsiloxane, and the absorbates thereof onto solid carrier material, for example Rhodorsil® 432 (silicone surfactant), butyl phosphate, isobutyl phosphate, n-octanol, Wacker ASP15 (polydimethylsiloxane, absorbed on solid carrier), Antifoam® SE (polydimethylsiloxane). Preference is given to suspoemulsions of hydrophobized silica particles in aqueous emulsion concentrates based on liquid silicone surfactants, such as Antifoam® SE (polydimethylsiloxane), and solid antifoams, such as Wacker ASP 15 (polydimethylsiloxane).

The invention further relates to a herbicidal composition which can be produced from the SCs according to the invention by diluting with liquids, preferably water.

It may be advantageous to add further active compounds to the herbicidal compositions thus obtained, preferably agrochemical active compounds (for example as tankmix partners in the form of appropriate formulations) and/or auxiliaries and additives customarily used, for example self-emulsifying oils such as vegetable oils or paraffin oils and/or fertilizers. The present invention therefore also provides such compositions, preferably herbicides, based on the formulations of the invention.

A particular embodiment of the invention relates to the use of the herbicidal compositions obtainable from the SCs according to the invention for control of unwanted vegetation, referred to hereinafter as “herbicidal composition”.

The herbicidal compositions have excellent herbicidal efficacy against a broad spectrum of economically important mono- and dicotyledonous harmful plants. There is also good control over difficult-to-control perennial weeds which produce shoots from rhizomes, rootstocks or other permanent organs. The herbicidal compositions may be applied, for example, by the pre-sowing, pre-emergence or post-emergence method. Specific examples of some representatives of the monocotyledonous and dicotyledonous weed flora which can be controlled by the herbicidal compositions are mentioned by way of example, though the enumeration is not intended to impose a restriction to particular species.

Examples of weed species which are controlled efficiently are, among the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and also Bromus spp. such as Bromus catharticus, Bromus secalinus, Bromus erectus, Bromus tectorum and Bromus japonicus and Cyperus species from the annual group, and, among the perennial species, Agropyron, Cynodon, Imperata and Sorghum and also perennial Cyperus species. In the case of dicotyledonous weed species, the spectrum of action extends to species such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The formulations of the invention are used preferably in rice, corn, wheat, barley, oats, rye, millet, and oilseed rape.

The herbicidal compositions also have excellent control over weeds that occur under the specific growing conditions that occur in rice, for example Echinochloa, Sagittaria, Alisma, Eleocharis, Scirpus and Cyperus. If the herbicidal compositions are applied to the soil surface before germination, either the weed seedlings are prevented completely from emerging or the weeds grow until they have reached the cotyledon stage, but then stop growing, and eventually, after three to four weeks have elapsed, die completely.

Said properties and advantages are beneficial in practical weed control in order to keep agricultural crops clear of unwanted competing plants and hence to ensure and/or increase the yields in terms of quality and quantity. The technical standard is markedly improved upon by these novel herbicidal compositions in terms of the properties described.

Even though the herbicidal compositions have excellent herbicidal activity against monocotyledonous and dicotyledonous weeds, there is only insignificant damage, if any, to crop plants of economically important crops, for example dicotyledonous crops such as soya, cotton, oilseed rape, sugar beet, or gramineous crops such as wheat, barley, rye, oats, millet/sorghum, rice or corn. For these reasons, the present herbicidal compositions are of very good suitability for selective control of unwanted plant growth in agriculturally useful plants or in ornamental plants.

Furthermore, the corresponding herbicidal compositions, according to the crop plant, have excellent growth-regulating properties. They intervene in the plants' own metabolism with regulatory effect, and can thus be used for the controlled influencing of plant constituents and to facilitate harvesting, for example by triggering desiccation and stunted growth. Furthermore, they are potentially also suitable for the general control and inhibition of unwanted vegetative growth without killing the plants in the process. Inhibition of vegetative growth plays a major role for many mono- and dicotyledonous crops since this can reduce or completely prevent lodging.

By virtue of their herbicidal and plant growth regulatory properties, the herbicidal compositions—as already mentioned—can also be used to control weeds in crops of genetically modified plants which are known or yet to be developed. In general, the transgenic plants are characterized by particular advantageous properties, for example by resistances to certain pesticides, in particular certain herbicides, resistances to plant diseases or pathogens of plant diseases, such as certain insects or microorganisms such as fungi, bacteria or viruses. Other particular properties relate, for example, to the harvested material with regard to quantity, quality, storability, composition and specific constituents. For instance, there are known transgenic plants with an elevated starch content or altered starch quality, or those with a different fatty acid composition in the harvested material.

Preference is given to the use of the herbicidal compositions in economically important transgenic crops of useful plants and ornamentals, for example of gramineous crops such as wheat, barley, rye, oats, millet/sorghum, rice and corn, or else crops of sugar beet, cotton, soya, oilseed rape, potatoes, tomatoes, peas and other vegetables. The herbicidal compositions can preferably be used in crops of useful plants which are resistant, or have been made resistant by recombinant means, to the phytotoxic effects of the herbicides.

When the herbicidal compositions are employed in transgenic crops, not only do the effects toward harmful plants to be observed in other crops occur, but frequently also effects which are specific to application in the particular transgenic crop, for example an altered or specifically widened spectrum of weeds which can be controlled, altered application rates which can be used for the application, preferably good combinability with the further herbicidally active compounds to which the transgenic crop is resistant, and influencing of growth and yield of the transgenic crop plants.

The present invention thus also provides a method for controlling unwanted plant growth, preferably in crop plants such as cereals (e.g. wheat, barley, rye, oats, rice, corn, millet/sorghum), sugar beet, sugar cane, oilseed rape, cotton and soya, more preferably in monocotyledonous crops such as cereals, for example wheat, barley, rye, oats, crossbreeds thereof, such as triticale, rice, corn and millet/sorghum, which is characterized in that the herbicidal compositions according to the invention are applied to the weeds, plant parts, plant seeds or the area in which the plants grow, for example the area under cultivation. The crop plants may also have been genetically modified or obtained by mutation selection and are preferably tolerant to acetolactate synthase (ALS) inhibitors.

With the formulations of the invention, a better biological efficacy can be achieved at the same application rate. Advantageously and surprisingly, the formulations of the invention exhibit excellent plant compatibility, such as a reduced tendency to cause phytotoxic damage.

In addition, the formulations of the invention in the form of specific active ingredient combination formulations (synonymously: mixture formulations, co-formulations) have further advantages, for example lower expenditure on packaging than in the case of use of the individual active ingredients, as a result of which the cost and inconvenience associated with production, transport and storage is reduced and the preparation of the spray liquors used in agriculture, through the smaller amounts and the effective ratios that have already been set, is better manageable, for example in the measuring and stirring operation.

The formulations of the invention surprisingly additionally exhibit excellent dispersing and stabilizing properties after further dilution with liquids, preferably water.

In addition, the formulations give rise to formulations which have prolonged storage stability and impeccable performance.

The formulations of the invention, moreover, exhibit particularly good herbicidal properties in dry soils, especially when DCPMI and flufenacet are used.

The particle size is determined according to CIPAC (CIPAC=Collaborative International Pesticides Analytical Council; www.cipac.org) Method MT 187 as d50 or D90 (active ingredient particle size, laser scattering, of 50% or 90% of all volume particles). The median particle size refers to the d50 value.

The invention is illustrated in more detail by the examples below, without being limited thereby.

### EXAMPLES

### Substances and Abbreviations Used

The terms used in the examples below have the following meanings:

| | |
|---|---|
| flufenacet | 4′-fluoro-N-isopropyl-2-(5-trifluoromethyl-1,3,4-thiadiazol-2-yloxy)acetamlide |
| | (Bayer AG), abbreviated hereinafter to FFA, log P = 3.2 |
| DCPMI | 2-[(2,4-dichlorophenyl)methyl]-4,4′-dimethyl-3-isoxazolidinone (CAS number |
| | 81777-95-9 or IUPAC 2-(2,4-dichlorobenzyl)-4,4-dimethyl-1,2-oxazolidin-3-one, |
| | abbreviated hereinafter to DCPMI), log P = 3.39 |
| Morwet ® D-425 | naphthalenesulfonic acid/formaldehyde condensate, sodium salt (Nouryon) |
| Pluronic ® PE 10500 | propylene oxide-ethylene oxide (PO-EO) block polymer (BASF) |
| citric acid | polybasic organic acid |
| Rhodopol ® G | xanthan derivative (Solvay) |
| Aerosil ® 200 | Synthetic amorphous silica (silicon dioxide, Evonik) |
| Silcolapse ® 426R, 411 | silicone defoamer (Elkam) |
| glycerol | antifreeze |
| Proxel ® GXL | preservative (biocide, Proxel) |
| Adjuvant 1 | C8-C10 alkylpolyglycoside, D-glucopyranose oligomers - decyl octyl glycosides, |
| | 60% glycoside and 40% water, CAS number 68515-73-1, BASF, Agnique ® PG |
| | 8105, log P 1.77; |
| Adjuvant 2 | polyoxyethylene-sorbitan fatty acid ester (20 EO), sorbitan monooleate, |
| | ethoxylated, made from oleic acid, with sorbitol and its anhydrides, CAS number |
| | 9005-65-6, Croda, Tween ® 80, log P about 2; |
| Adjuvant 3 | polyoxyethylene-sorbitan fatty acid ester (20 EO), sorbitan monolaurate, |
| | ethoxylated, made from lauric acid, with sorbitol and its anhydrides, CAS number |
| | 9005-64-5, Croda, Tween ® 20, log P about −0.55; |

The log P describes the partition particularly of active pesticidal ingredients between water and n-octanol. Banerjee et al., 1980, S. Banerjee, S. H. Yalkowsky, S. C. Valvani, Water solubility and octanol/water partition coefficients of organics. Limitations of the solubility-partition coefficient correlation, Environ. Sci. Technol., 14 (1980), pp. 1227-1229.

### Production Example

### SC Formulations:

The ZC formulations of the invention were produced by producing the SC formulations that follow as mixing partners. These are blended with the formulations of the invention to give further formulations of the invention.

### Production of an Aqueous Suspension Concentrate:

For production of the examples cited in Table 1, water is initially charged at room temperature. The further components are then added (in no particular order) with stirring. This is followed by wet grinding, for example by means of a bead mill. Finally, the organic thickener is added.

TABLE 1
Formulations produced (figures are
in percent by weight, % by weight)

| | | SC-1 | SC-2 |
|---|---|---|---|
| A | DCPMI | 42.37 | |
| A | flufenacet | | 42.37 |
| B | Morwet ® D- | 1.0 | 1.0 |
| | 425 | | |
| B | Pluronic ® PE | 5 | 5 |
| | 10500 | | |
| G | citric acid | 0.1 | 0.1 |
| F | Aerosil ® 200 | 0.5 | 0.5 |
| F | Rhodopol ® 23 | 0.2 | 0.2 |
| G | Silcolapse ® 411 | 0.5 | 0.5 |
| G | glycerol | 5 | 5 |
| G | Proxel ® GXL | 0.18 | 0.18 |

Water is added to give a total of 100%

| | | |
|---|---|---|
| Density of the formulation | 1.19 | 1.19 |
| g/L active ingredient content | 500 | 500 |

### Ready-to-Use Formulations Produced

The ready-to-use formulations were produced by mixing SC-1 and also SC-2 through addition of the corresponding adjuvant quantities. % by weight were used in each case. For comparison, the respective formulations were taken as 100%. The completed formulations underwent greenhouse testing.

### Greenhouse Trials:

In the standard implementation of the test, seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated on a laboratory track sprayer with spray liquors comprising the mixtures/compositions of the invention, mixtures of the prior art or the components applied individually. Application of the active ingredients or active ingredient combinations formulated as WG, WP, EC or otherwise was effected at the appropriate growth stages of the plants. The amount of water used for spray application was 100-600 l/ha. After the treatment, the plants were returned to the greenhouses.

About 3 weeks after the application, the soil action or/and foliar action was assessed visually according to a scale of 0-100% in comparison to an untreated comparative group: 0%=no noticeable effect compared to the untreated comparative group; 100%=full effect compared to the untreated comparative group.

(Notes: the term “seeds” also includes vegetative propagation forms such as, for example, rhizome pieces; abbreviations used: h light=hours of illumination, g of AS/ha=grams of active substance per hectare, 1/ha=liters per hectare, S=sensitive, R=resistant)
1. Pre-emergence action against weeds: seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at BBCH stage 00-10 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required.
2. Post-emergence action against weeds: seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at various BBCH stages between 11-25 of the seeds/plants, i.e. generally between two to three weeks after the start of the cultivation, on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required.
3. Pre-emergence action against weeds with and without active ingredient incorporation: Seeds of various broad-leaved weed and weed grass biotypes (origins) were sown in an 8-13 cm diameter pot filled with natural soil of a standard field soil (loamy silt; non-sterile). By way of comparison, the pots with the seeds were treated at BBCH stage 00-10 of the seeds/plants, i. e. generally between two to three weeks after the start of the cultivation, on a laboratory track sprayer either with spray liquors comprising the mixtures/compositions of the invention, mixtures or the components applied individually as WG, WP, EC or other formulations, or an equivalent amount of the mixtures/compositions of the invention, mixtures or the components applied individually as WG, WP, EC or other formulations was incorporated into the 1 cm covering layer. The amount of water used for spray application was 100-6001/ha. After the treatment, the plants were returned to the greenhouses and fertilized and watered as required. The pots were cultivated in a greenhouse (light for 12-16 h, temperature 20-22° C. by day, 15-18° C. by night).
4. Selective pre-emergence action: seeds of various crop species (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at BBCH stage 00-10 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required.
5. Selective post-emergence action: seeds of various crop species (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at various BBCH stages 11-32 of the seeds/plants, i.e. generally between two to four weeks after the start of the cultivation, on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night).
6. Effect on weeds in pre-sowing application: Seeds of various broad-leaved weed and weed grass biotypes (origins) were sown in an 8-13 cm diameter pot filled with natural soil of a standard field soil (loamy silt; non-sterile). The pots with the seeds were treated prior to sowing on a laboratory track sprayer with spray liquors comprising the mixtures/compositions of the invention, mixtures or the components applied individually as WG, WP, EC or other formulations. The amount of water used for spray application was 100-600 l/ha. After sowing, the pots were placed in the greenhouses and fertilized and watered as required. The pots were cultivated in a greenhouse (light for 12-16 h, temperature 20-22° C. by day, 15-18° C. by night).
7. Pre-emergence and post-emergence action against weeds under various cultivation conditions: seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night). Irrigation was varied according to the issue. Here, the individual comparative groups were provided with gradually differing amounts of water in a range from above the PWP (permanent wilting point) up to the level of maximum field capacity.
8. Pre-emergence and post-emergence action against weeds under various irrigation conditions: seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night). The individual comparative groups were subjected to different irrigation techniques. Irrigation was either from below or gradually from above (simulated rain).
9. Pre-emergence and post-emergence action against weeds under various soil conditions: Seeds of various broad-leaved weed and weed grass biotypes (origins) were sown in an 8-13 cm diameter pot filled with natural soil and covered with a covering soil layer of about 1 cm. To compare the herbicidal action, the plants were cultivated in various cultivation soils from sandy soil to heavy clay soil and various contents of organic substance. The pots were then cultivated in a greenhouse (light for 12-16 h, temperature 20-22° C. by day, 15-18° C. by night) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night).
10. Pre-emergence and post-emergence action against weeds for the control of resistant weed grass/broad-leaved weed species: seeds of various broad-leaved weed and weed grass biotypes (origins) having various resistance mechanisms against different modes of action were sown in an 8 cm diameter pot filled with natural soil of a standard field soil (loamy silt, LSI; pH 7.4; % C org 2.2) and covered with a covering soil layer of about 1 cm. The pots were then cultivated in a greenhouse (12-16 h light, temperature day about 23° C., night about 15° C.) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 300 l/ha. After the treatment, the plants were returned to the greenhouses and fertilized and watered as required. The pots were cultivated in a greenhouse (12-16 h light, temperature day about 23° C., night about 15° C.).
11. Pre-emergence and post-emergence action against weeds and crop selectivity under various sowing conditions: seeds of various broad-leaved weed and weed grass biotypes (origins) and crop species (origins) were sown in an 8-13 cm diameter pot filled with natural soil and covered with a covering soil layer of about 0-5 cm. The pots were then cultivated in a greenhouse (light for 12-16 h, temperature 20-22° C. by day, 15-18° C. by night) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night).
12. Pre-emergence and post-emergence action against weeds at different pH values of the soil: Seeds of various broad-leaved weed and weed grass biotypes (origins) were sown in an 8-13 cm diameter pot filled with natural soil and covered with a covering soil layer of about 1 cm. For comparison of the herbicidal activity, the plants were cultivated in cultivation soils of a standard field soil (loamy silt; non-sterile) with different pH values of pH 7.4 and pH 8.4. Accordingly, the soil was mixed with lime to achieve the higher pH value. The pots were then cultivated in a greenhouse (light for 12-16 h, temperature 20-22° C. by day, 15-18° C. by night) until the time of application. The pots were treated at various BBCH stages 00-10 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night).

The studies were made for different levels of soil dryness.

Humid conditions: The test pots were watered daily with 11 of water per m².

Dry conditions: The test pots were watered daily with 0.25 l of water per m².

Normal conditions: The test pots were watered daily with 0.5 l of water per m².

Results from the Greenhouse:

Each of the formulations of the invention, with comparative examples 1-3, were tested for their activity against typical broadleaf and gramineous weeds. The application window was early pre-emergence (BBCH 11). The greenhouse application rate is 100 g/ha DCPMI, which correlates to a typical field application rate of 200 g/ha DCPMI (the transfer factor from greenhouse to field is therefore 2). The pots were tested respectively under humid, normal and dry conditions. Testing with flufenacet took place at 125 g/ha. In each case, the formulation was mixed with the adjuvant and then applied. The dilution selected was typically 100 L/ha of water.

Application rate used in g/ha

| | Formulation | FFA | DCPMI | Adjuvant 1 | Adjuvant 2 |
|---|---|---|---|---|---|
| Example | used | g/ha | g/ha | g/ha | g/ha |
| Comparison 1 | SC-1 | | 100 | | |
| Comparison 2 | SC-2 | 125 | | | |
| Inventive example 1 | SC-1 with Adjuvant 1 | | 100 | 1000 | |
| Inventive example 2 | SC-1 with Adjuvant 1 | | 100 | 500 | |
| Inventive example 3 | SC-1 with Adjuvant 1 | | 100 | 250 | |
| Inventive example 4 | SC-1 with Adjuvant 2 | | 100 | | 1000 |
| Inventive example 5 | SC-1 with Adjuvant 2 | | 100 | | 500 |
| Inventive example 6 | SC-1 with Adjuvant 2 | | 100 | | 250 |
| Inventive example 7 | SC-2 with Adjuvant 1 | 125 | | 1000 | |
| Inventive example 8 | SC-2 with Adjuvant 1 | 125 | | 500 | |
| Inventive example 9 | SC-2 with Adjuvant 1 | 125 | | 250 | |
| Inventive example 10 | SC-2 with Adjuvant 2 | 125 | | | 1000 |
| Inventive example 11 | SC-2 with Adjuvant 2 | 125 | | | 500 |
| Inventive example 12 | SC-2 with Adjuvant 2 | 125 | | | 250 |

Activity against granmineous weeds under humid, normal and dry conditions. Studies were conducted on each of the following important gramineous weeds in winter cereals:

AVEFA=Avena fatua=wild oat
ALOMY=Alopecurus myosuroides=blackgrass
APESY=Apera spica-venti=loose silky bent
LOLMU=Lolium mulitflorum=Italian ryegrass

| | % control against | % control against | % control against |
|---|---|---|---|
| Formulation | AVEFA/ALOMY/APESY/LOLMU | AVEFA/ALOMY/APESY/LOLMU | AVEFA/ALOMY/APESY/LOLMU |
| used | dry | normal | humid |
| Comparison 1 | 40/95/10/95 | 30/95/10/80 | 30/90/10/80 |
| Comparison 2 | 30/90/100/30 | 80/100/100/85 | 95/98/100/95 |
| Inventive example 1 | 40/100/10/95 | 30/95/20/90 | 40/100/10/95 |
| Inventive example 2 | 40/100/10/95 | 30/95/20/80 | 40/90/10/80 |
| Inventive example 3 | 70/95/10/95 | 50/100/10/90 | 30/100/10/90 |
| Inventive example 4 | 80/95/10/95 | 30/90/20/90 | 40/99/10/90 |
| Inventive example 5 | 70/99/10/95 | 50/95/10/95 | 40/90/10/90 |
| Inventive example 6 | 60/99/10/99 | 30/90/10/70 | 35/100/10/90 |
| Inventive example 7 | 40/95/100/90 | 80/98/100/98 | 95/100/100/98 |
| Inventive example 8 | 40/95/100/70 | 90/98/100/97 | 95/100/100/97 |
| Inventive example 9 | 40/95/100/60 | 80/98/100/95 | 95/98/100/97 |
| Inventive example 10 | 40/95/100/30 | 50/100/100/70 | 90/100/100/98 |
| Inventive example 11 | 40/95/100/30 | 45/100/100/70 | 90/100/100/100 |
| Inventive example 12 | 40/98/100/30 | 40/100/100/70 | 85/100/100/95 |

The two selected active ingredients exhibit significant improvements particularly for AVEFA and LOLMU with the adjuvants. For greater ease of comparison, the absolute improvement in percentage points has been shown in the table below. The numbers are transposed from the upper table and, under the respective conditions, show the percentage reduction/control of the gramineous weeds AVEFA and LOLMU.

| | AVEFA | LOLMU | AVEFA | LOLMU | AVEFA | LOLMU |
|---|---|---|---|---|---|---|
| | dry | dry | normal | normal | humid | humid |
| Comparison 2 | 30 | 30 | 80 | 85 | 95 | 95 |
| Example 9 | 40 | 60 | 80 | 95 | 95 | 97 |
| improvement | 10 | 30 | 0 | 10 | 0 | 2 |
| Example 8 | 40 | 70 | 90 | 97 | 95 | 97 |
| improvement | 10 | 40 | 10 | 12 | 0 | 2 |
| Example 7 | 40 | 90 | 80 | 98 | 95 | 98 |
| improvement | 10 | 60 | 0 | 13 | 0 | 3 |
| Example 12 | 40 | 30 | 40 | 70 | 85 | 95 |
| improvement | 10 | 0 | −40 | −15 | −10 | 0 |
| Example 11 | 40 | 30 | 45 | 70 | 90 | 100 |
| improvement | 10 | 0 | −35 | −15 | −5 | 5 |
| Example 10 | 40 | 30 | 50 | 70 | 90 | 98 |
| improvement | 10 | 0 | −30 | −15 | −5 | 3 |
| Comparison 1 | 40 | 95 | 30 | 80 | 30 | 80 |
| Example 3 | 70 | 95 | 50 | 90 | 30 | 90 |
| improvement | 30 | 0 | 20 | 10 | 0 | 10 |
| Example 2 | 40 | 95 | 30 | 80 | 40 | 80 |
| improvement | 0 | 0 | 0 | 0 | 10 | 0 |
| Example 1 | 40 | 95 | 30 | 90 | 40 | 95 |
| improvement | 0 | 0 | 0 | 10 | 10 | 15 |
| Example 6 | 60 | 99 | 30 | 70 | 35 | 90 |
| improvement | 20 | 4 | 0 | −10 | 5 | 10 |
| Example 5 | 70 | 95 | 50 | 95 | 40 | 90 |
| improvement | 30 | 0 | 20 | 15 | 10 | 10 |
| Example 4 | 80 | 95 | 30 | 90 | 40 | 90 |
| improvement | 40 | 0 | 0 | 10 | 10 | 10 |

The formulations of the invention with the active herbicidal ingredients display a significantly higher activity with the two adjuvants 1 and 2. Under dry conditions especially, the adjuvants display a significant improvement in activity. For flufenacet it was found that especially adjuvant 1 at between 250 and 1000 g/ha gave a consistent significant improvement in the activity. The activity of adjuvant 2 was better under dry conditions, poorer under humid conditions.

DCPMI with both adjuvants from as low as 250 g/ha displayed a significant improvement.

The blends of SC-1 and -2 with adjuvant 3, conversely, displayed no improvement in activity.

1. A formulation comprising
a) DCPMI and/or at least one preemergence herbicide,
b) at least one dispersant,
c) at least one activity enhancer selected from the group encompassing organically modified (poly)-glycosides, -furanoses and -pyranoses, and organically modified sorbitans and/or sorbitols,
d) optionally at least one agrochemical active compound different from a),
e) optionally at least one safener,
f) optionally at least one thickener,
g) optionally further additives and auxiliaries, and
h) water.

2. The formulation as claimed in claim 1, wherein the preemergence herbicide a) is selected from the group consisting of acetochlor, aclonifen, flufenacet, diflufenican, clomazone, pendimethalin, pyroxasulfone, cinmethylin, and dimethenamid.

3. The formulation as claim 1, wherein the proportion of active ingredient a) in the formulation is optionally 0.5 to 55.0% by weight, optionally 0.5 to 45.0% by weight, optionally 5.0 to 40.0% by weight, and optionally 10.0 to 40.0% by weight.

4. The formulation as claimed in claim 1, wherein the proportion of dispersant b) is optionally 1.0 to 15.0% by weight, optionally 2.0 to 10.0% by weight, and optionally 2.5 to 8.0% by weight.

5. The formulation as claimed in claim 1, the proportion of the activity enhancer c) is optionally 5.0 to 95.0% by weight, optionally 10.0 to 90.0% by weight, and optionally 20.0 to 80.0% by weight.

6. The formulation as claimed in claim 1, wherein said dispersant comprises a combination of at least one ionic and one nonionic dispersant, optionally a combination of sulfonates, and a nonionic dispersant from the group of tristyrylphenol ethoxylates, tristyrylphenol ethoxypropoxylates, and castor oil polyglycol ether esters.

7. The formulation as claimed in claim 1, wherein the activity enhancer c) is selected from the group consisting of organically modified (poly)glycosides, organically modified furanoses, organically modified pyranoses, and organically modified sorbitans and sorbitols, and/or a mixture thereof.

8. The formulation as claimed in claim 7, wherein c) is an alkylpolysaccharide.

9. The formulation as claimed in claim 8, wherein the alkylpolysaccharide has a general structure of formula (I): 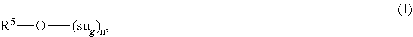
where R5 is an unbranched or branched, optionally substituted or unsubstituted hydrocarbyl radical selected from the group consisting of alkyl, alkenyl, alkylphenyl and alkenylphenyl, preferably having 4 to 22 carbon atoms, and
the su_{g} unit is a saccharide radical with open or cyclic structure, the saccharide radical being selected from the group consisting of monosaccharides, disaccharides, and polysaccharides.

10. The formulation as claimed in claim 7, wherein c) is alkoxylated polysorbate ester.

11. The formulation as claimed in claim 10, wherein c) is an alkoxylated polysorbate ester of formula (II), 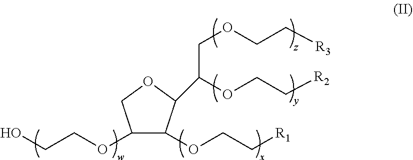
where R1, R2 and R3 are fatty acid radicals or a hydroxyl radical, and the substituents R1 to R3 may be identical or different, and w, x, y and z are integers from 0 to 20, with 0 corresponding to an OH group.

12. A product comprising a formulation as claimed in claim 1 as an herbicide in dry soil.

13. A preemergence product comprising the formulation as claimed in claim 1 as a herbicide in rice, corn, wheat, barley, oats, rye, millet, and/or oilseed rape.

14. The product as claimed in claim 13 in dry soil.

15. The product as claimed in claim 12 against Avena fatua (wild oat), Alopecurus myosuroides (blackgrass), Apera spica-venti (loose silky bent), and Lolium multiflorum (Italian ryegrass).

16. A method for control of unwanted vegetation, optionally against Avena fatua (wild oat), Alopecurus myosuroides (blackgrass), Apera spica-venti (loose silky bent), and Lolium multiflorum (Italian ryegrass), said method comprising applying a formulation of claim 1 to a locus in need thereof.

17. The method of claim 16, wherein said formulation is applied as a preemergence herbicide in rice, corn, wheat, barley, oats, rye, millet, and/or oilseed rape.
